(19) United States
(12) Patent Application Publication
(10) Pub. No.: US 2009/0225786 A1
(43) Pub. Date: Sep. 10, 2009

(54) Delay line combination receiving method for ultra wideband system

(76) Inventors: Jyh Horng Wen, Taichung (TW); Hsi Chou Hsu, Changhua (TW)

Correspondence Address: BACON & THOMAS, PLLC, 625 SLATERS LANE, FOURTH FLOOR, ALEXANDRIA, VA, 22314-1176, US

(21) Appl. No.: 12/073,737

(22) Filed: Mar. 10, 2008

(51) Int. Cl. H04J 3/00

(52) U.S. Cl. 370/498

(57) ABSTRACT

The present invention relates to a delay line combination receiving method for ultra wideband system, which comprises a frame-differential delay line, which is collecting and combining all multi-path signals from desired users, and a delay line combination receiver, which is detecting the time at the sharpest rising or falling edge of the continuous integration output of the combinative output signal provided by said frame-differential delay line. Said the time at the sharpest rising or falling edge of the continuous integration output is the arrival time of the first signal of each symbol. The present can improve the synchronization speed of differential impulse radio ultra-wideband systems.

### BACKGROUND OF THE INVENTION

1. Field of the Invention

The present invention relates to a receiving method for Ultra Wideband Systems, particularly it pertains to a delay line combination receiving method for ultra wideband system cable of improving the synchronization speed of differential impulse radio ultra-wideband systems.

2. Description of the Related Art

In recent years, due to approbation and establishment standard of The Federal Communications Commission (FCC), Ultra Wideband System has already been subjected to focus attention, and becomes the most optimistic wireless technique. The attractive characteristics of Ultra Wideband System are short distance of anti-multiple path declination and the data transferring with high speed and low power. The UWB technique that has been already standardized and widely applied currently is the technique of Multiband OFDM(MB-OFDM) put forth by Alliance(MBOA). Another technique which is not commercial yet but widely researched is Time-Hopping Impulse Radio (TH-IR) UWB. Inventor provides a simple structure and efficiency receiver and a synchronous algorithm for applying on the Time-Hopping Impulse Radio (TH-IR) UWB system.

A rake receiver is usually used to receive signal for collecting multi-path signals. However, the delay time and attenuation of signals from each path are needed to know in advance. If more signal energy is needed, the number of fingers of the rake receiver must be increased and the complexity of hardware also be increased. Besides, in most situations, the information of channel can not be estimated precisely before synchronization. It is hardly to get ideal result by using a rake receiver in this time. A method of transmitting signals called transmitted reference (TR) [1, 2] is widely discussing within UWB for providing a solution for the problem mentioned above. Please refer to FIG. 1. FIG. 1 is a diagram showing the structure of differential correlator. With the kind of TR structure, a pair of signals (pulse pair) is transmitted from transmitters. The first signal is called as reference pulse, and the second signal is called as data pulse. One or several differential correlators are used in receiver end. The advantages of using the TR advantage are multi-path signals could be received completely without estimating the information of the channel in advance, and it is not necessary for receivers to produce a template signal. In conclusion, the structure of TR is pretty simple.

However, the TR exists two major disadvantages. One is that it needs ultra bandwidth and energy to transmit the template signal, the other one is that the inter-frame interference (IFI) will occur because the time interval of the template signal and data signal is not long enough. When data rate is higher, the effect of IFI will be more serious.

According to the above-mentioned reason, another receiving method called frame differential [3, 4] is used to avoid these disadvantages.

The algorithm of frame differential is that it delays the each signal for its delay time (Di) and applies the correlate process with all the delay signals. Said delay time [Di] is the time interval between the two signals. Please refer to FIG. 2, FIG. 2 is a diagram showing the structure of frame differential receiver.

Frame differential could reserve the advantage of TR and overcome the disadvantage of TR. But the complicated timing control can not be avoided.

Besides, it is very difficult to process the synchronization of signal due to very low signal power and very short pulse of Ultra Wideband System transmitting. Some researches are already deeply discussed with synchronization method of the frame differential structure. A rather novel synchronous method called the timing with dirty templates (TDT had been provided from the cultural heritage [5].

There are four kinds of synchronous algorithms for evolving in the cultural heritage [5]. The first one is data aided, the others are the method of the non-data. The structure of transmitting and receiving is as figure as FIG. 3.

The operation way of TDT is that it transmits a fixed bit value (1, 1, −1, −1) sequence. The correlation process is taken between current and the next symbol-long segment of receiving signals. By the way, it will provide a larger correlation value output than the correlation value output at the non-beginning of the sign boundary.

As shown in FIG. 3, the largest value output will provided. Consequently, the operation way of TDT is that it provides the observed output passing through correlator by adjusting the T value figured at FIG. 3. After finish testing all probably of T, the value T who provide the largest value output of correlator will be selected. The value T at this time would be the predicted propagation delay.

### SUMMARY OF THE INVENTION

In view of the imperfections of conventional receiving method, the inventor of the present invention has spent years researching and developing innovative communication technology and eventually came up with a delay line combination receiving method for ultra wideband system.

The major purpose of present invention is to provide a delay line combination receiving method for ultra wideband system which cable of improving the synchronization speed of differential impulse radio ultra-wideband systems.

Another purpose of this invention is to provide delay line combination receiving method for ultra wideband system which cable of timing synchronization within single symbol duration.

These and other objects, features and advantages of the present invention will become more apparent from the following description and the appended claims, taken in connection with the accompanying drawings in which preferred embodiment of the present invention are shown by way of illustrative example.

### DETAILED DESCRIPTION OF THE PREFERRED EMBODIMENT

The present invention relates to a delay line combination receiving method for ultra wideband system, which comprises a frame-differential delay line, which is providing a maximum integration output by collecting and combining all of the candidate time offsets, and a delay line combination receiver (it includes a timing with delay line combination algorithm and demodulation process), which is detecting the sharpest rising or falling edge of the continuous integration output of the combinative output signal provided by said frame-differential delay line during one symbol period.

Please refer to FIG. 4, it shows the frame-differential delay line (FDL) of the present invention. It is simpler than frame differential shown in FIG. 2. Besides, a complex timing control is not necessary (its operation way will be explained later). Please refer to FIG. 5. and FIG. 6. The invention also includes a delay time combination receiver (DLC). Companied with the output signal of FDL, a fast synchronizing algorithm called timing with delay line combination (TDLC) is developed upon DLC receiver. Said synchronizing algorithm will reach synchronization during one symbol period. It is fast up many times than other algorithms developed on TH-IR UWB system currently. After getting the transmitted signal's receiving time derived from TDLC algorithm, then a modulation process will be applied on the output signal of FDL. The TDLC algorithm can continuously tracking bit time while transmitting data signal due to the TDLC algorithm could not rely on particular training pattern. Therefore DLC receivers can be carried out with the easy hardware structure. The present invention provides a novel non-data aided (NDA) synchronization algorithm designated as the “timing with delay line combination” (TDLC) algorithm. In contrast to TDT algorithms, which rely on acquiring a maximum integration output by testing all of the candidate time offsets (T, the candidate time offsets could be pre-decided or adjusted), the synchronization criterion of the TDLC algorithm is based on detecting the time at the sharpest rising or falling edge of the continuous integration output of the combinative output signal provided by the frame-differential delay line (FDL) during one symbol period. Said the time at the sharpest rising or falling edge of the continuous integration output is the arrival time of the first signal of each symbol. The TDT algorithm requires 2K×Ni symbol periods for each round, where K is the number of pairs of symbol-long received segments required for reliable estimation and Ni is the number of candidate time offsets. However, the proposed TDLC algorithm requires just one symbol period per round. Therefore, the TDLC algorithm is superior to the TDT algorithms in terms of its synchronization speed. The present simulation results also demonstrate that the TDLC algorithm achieves a higher probability of detection (PD) and mean square error (MSE) than the TDT algorithms in both multi-path and multi-user environments.

Following signal models are used for further explanation:

The transmitted signal from the kth user is given by

$${s}_{k} ( t ) = {\sum }_{i = - ∞}^{∞} {\sum }_{j = 0}^{{N}_{f} - 1} {( {d}_{k , i} )}^{j} w ( t - {iT}_{s} - {jT}_{f} - {c}_{k , j} {T}_{c} ) , \qquad ( 1 )$$

where k is the user index; i is the symbol index; j is the frame index; dₖᵢ∈{+1, −1} is the data sequence for the kth active user; w(t) is the transmitted pulse waveform; Tₛ is the symbol duration; T_{f} is the pulse repetition time; {c_{k,j}}ⱼ₌₀^{N}^{_{f}}⁻¹ is the time hopping (TH) code; and T_{c} is the chip duration. Each symbol is transmitted in N_{f} successive frames, where N_{f} is an even number, with one pulse per frame and the jth transmitted pulse of the ith symbol is modulated by (d_{k,i})^{j}.

As discussed in [3], let D_{k,p} indicate the time offset between the pth and the (p+1)th transmitted pulses from the kth user, where D_{k,p}=T_{f}+(c_{k,mod(p+1,N}_{_{f}}₎−c_{k,mod(p,N}_{_{f}}₎)×T_{c} for p∈[0,N_{f}−1]. Eq. (1) can then be rewritten as

$${s}_{k} ( t ) = {\sum }_{i = - ∞}^{∞} {\sum }_{j = 0}^{{N}_{f} - 1} {( {d}_{k , i} )}^{j} w ( t - {iT}_{s} - {c}_{k , 0} {T}_{c} - {\sum }_{p = 0}^{j - 1} {D}_{k , p} ) , \qquad ( 2 )$$

where

$${\sum }_{p = 0}^{- 1} {D}_{k , p} = 0$$

is defined.

The multi-path channel corresponding to each user k is modeled as a tap delay line with Lₖ taps, whose amplitudes {a_{k,l}}ₗ₌₁^{L}^{ₖ} and delays {τ_{k,l}}ₗ₌₁^{L}^{ₖ} are invariant over one symbol duration. The channel impulse response is given by

$${h}_{k} ( t ) = {\sum }_{l = 1}^{{L}_{k}} {α}_{k , l} δ ( t - {τ}_{k , l} ) , \qquad ( 3 )$$

where τ_{k,l} is the propagation delay of the first arrival signal.

The aggregated waveform for all of active users has the form

$$\begin{matrix}r ( t ) = {\sum }_{k = 0}^{{N}_{u} - 1} {s}_{k} ( t ) * {h}_{k} ( t ) + n ( t ) \\ = {\sum }_{k = 0}^{{N}_{u} - 1} {\sum }_{i = - ∞}^{∞} {\sum }_{j = 0}^{{N}_{f} - 1} {\sum }_{l = 1}^{{L}_{k}} {( {d}_{k , i} )}^{j} {α}_{k , l} w \\ ( t - {iT}_{s} - {c}_{k , 0} {T}_{c} - {\sum }_{p = 0}^{j - 1} {D}_{k , p} - {τ}_{k , l} ) + n ( t ) , \\ = {\sum }_{k = 0}^{{N}_{u} - 1} {\sum }_{i = - ∞}^{∞} {\sum }_{j = 0}^{{N}_{f} - 1} {v}_{k , i , j} ( t ) + n ( t )\end{matrix} \qquad ( 4 )$$

where Nᵤ is the total number of active users; n(t) is the additive Gaussian noise, and

$${v}_{k , i , j} ( t ) = {( {d}_{k , i} )}^{j} {\sum }_{l = 1}^{{L}_{k}} {α}_{k , l} w ( t - {iT}_{s} - {c}_{k , 0} {T}_{c} - {\sum }_{p = 0}^{j - 1} {D}_{k , p} - {τ}_{k , l} ) .$$

Since {a_{k,l}}ₗ₌₁^{L}^{ₖ} and {τ_{k,l}}ₗ₌₁^{L}^{ₖ} are invariant over one symbol duration,

$${v}_{k , i , j} ( t ) = {( {d}_{k , i} )}^{j} {v}_{k , i , 0} ( t - {\sum }_{p = 0}^{j - 1} {D}_{k , p} ) .$$

. Eq. (4) can be rewritten as

$$r ( t ) = {\sum }_{k = 0}^{{N}_{u} - 1} {\sum }_{i = - ∞}^{∞} {\sum }_{j = 0}^{{N}_{f} - 1} {( {d}_{k , i} )}^{j} {v}_{k , i , 0} ( t - {\sum }_{p = 0}^{j - 1} {D}_{k , p} ) + n ( t ) \qquad ( 5 )$$

The delay line combination (DLC) receiver proposed in this study is derived from the differential IR-UWB system presented in [3]. However, in the current DLC receiver, the delay elements are arranged in a cascade rather than in parallel. This sequence of delay elements is designated as the “frame-differential delay line” (FDL). The delays in the FDL are denoted by D_{k,N}_{_{f}}₋₁, D_{k,N}_{_{f}}₋₂, . . . , D_{k,0}, sequentially

As shown in FIG. 1, the active user is indexed as 0, and y(t) is the combinative output signal of the N_{f} tap branches of the FDL. The continuous integration output of y(t) is given by

$$\begin{matrix}z ( t ) = {\int }_{0}^{t} y ( x ) d x \\ = {\sum }_{m = 0}^{{N}_{f} - 1} {\int }_{0}^{t} r ( x - {\sum }_{p = m}^{{N}_{f} - 1} {D}_{0 , p} ) \times r ( x - {\sum }_{p = m + 1}^{{N}_{f} - 1} {D}_{0 , p} ) d x ,\end{matrix} \qquad ( 6 )$$

where

$${\sum }_{p = {N}_{f}}^{{N}_{f} - 1} {D}_{0 , p} = 0$$

is defined.

The DLC receiver introduces a delay time T_{w}. Note that the value of T_{w} should be designed appropriately in order to optimize the performance of the proposed synchronization algorithm. Generally, it is reasonable to assume T_{W}≦T_{mds}^{(k)}, where T_{mds}^{(k)}=τ_{k,L}_{ₖ}−τ_{k,l} is the maximum delay spread under the channel impulse response hₖ(t). Subtracting z(t−T_{w}) from z(t) gives

$$\begin{matrix}α ( t ) = z ( t ) - z ( t - {T}_{w} ) \\ = {\sum }_{m = 0}^{{N}_{f} - 1} {\int }_{t - {T}_{w}}^{t} r ( x - {\sum }_{p = m}^{{N}_{f} - 1} {D}_{0 , p} ) \times r ( x - {\sum }_{p = m + 1}^{{N}_{f} - 1} {D}_{0 , p} ) d x .\end{matrix} \qquad ( 7 )$$

Substituting Eq. (5) into Eq. (7), yields

$$α ( t ) = {\sum }_{m = 0}^{{N}_{f} - 1} {\int }_{t - {T}_{w}}^{t} \{ {\sum }_{{k}_{1} = 0}^{{N}_{u} - 1} {\sum }_{{i}_{1} = - ∞}^{∞} {\sum }_{{j}_{1} = 0}^{{N}_{f} - 1} {( {d}_{{k}_{1} , {i}_{1}} )}^{{j}_{1}} {v}_{{k}_{1} , {i}_{1} , 0} ( x - {\sum }_{p = 0}^{{j}_{1} - 1} {D}_{{k}_{1} , p} - {\sum }_{p = m}^{{N}_{f} - 1} {D}_{0 , p} ) + n ( x - {\sum }_{p = m}^{{N}_{f} - 1} {D}_{0 , p} ) \} \times \{ {\sum }_{{k}_{2} = 0}^{{N}_{u} - 1} {\sum }_{{i}_{2} = - ∞}^{∞} {\sum }_{{j}_{2} = 0}^{{N}_{f} - 1} {( {d}_{{k}_{2} , {i}_{2}} )}^{{j}_{1}} {v}_{{k}_{2} , {i}_{2} , 0} ( x - {\sum }_{p = 0}^{{j}_{2} - 1} {D}_{{k}_{2} , p} - {\sum }_{p = m + 1}^{{N}_{f} - 1} {D}_{0 , p} ) + n ( x - {\sum }_{p = m + 1}^{{N}_{f} - 1} {D}_{0 , p} ) \} d x . \qquad ( 8 )$$

Extracting the desired terms with indexes k₁=k₂=0, i₁=i₂, j₁=m, and j₂=m+1 from Eq. (8) gives

$$α ( t ) = {\sum }_{m = 0}^{{N}_{f} - 1} {\sum }_{i = - ∞}^{∞} {\int }_{t - {T}_{w}}^{t} {( {d}_{0 , i} )}^{m} {v}_{0 , i , 0} ( x - {\sum }_{p = 0}^{m - 1} {D}_{0 , p} - {\sum }_{p = m}^{{N}_{f} - 1} {D}_{0 , p} ) \times {( {d}_{0 , i} )}^{m + 1} {v}_{0 , i , 0} ( x - {\sum }_{p = 0}^{m} {D}_{0 , p} - {\sum }_{p = m + 1}^{{N}_{f} - 1} {D}_{0 , p} ) d x + Ψ ( t ) , = ( {N}_{f} ) {\sum }_{i = - ∞}^{∞} ( {d}_{0 , i} ) {\int }_{t - {T}_{w}}^{t} {v}_{0 , i , 0}^{2} ( x - {T}_{s} ) d x + Ψ ( t ) \qquad ( 9 )$$

where Ψ(t) denotes the noise and interference terms. If Ψ(t) is ignored, |α(t) | exhibits a local maximum when t−T_{w}=(i+1)Tₛ+τ_{0,1}+c_{0,0}T_{c} for each symbol index i. Therefore, the true symbol boundary, i.e. t_{symbol}⁽ⁱ⁺¹⁾=(i+1)Tₛ+τ_{0,1}, can be determined by detecting the time at which |α(t)| exhibits its local maximum during each symbol period.

FIG. 7 illustrates the synchronization scenario of the TDLC algorithm. The time at which |α(t)| exhibits its local maximum is denoted by \hat{t}ₘₐₓ⁽ⁱ⁺¹⁾ and is estimated in accordance with the criterion

$${\hat{t}}_{max}^{( i + 1 )} = {arg max}_{{t}_{i} < t \leq {t}_{i + 1}} ( \vert α ( t ) \vert ) , where {t}_{i} = i \times ( {N}_{f} + 1 ) {T}_{f} , \qquad ( 10 )$$

then the estimated arrival time of the first signal in the (i+1)th symbol \hat{t}_{signal}⁽ⁱ⁺¹⁾ can be derived by

\hat{t}_{signal}⁽ⁱ⁺¹⁾=\hat{t}ₘₐₓ⁽ⁱ⁺¹⁾−T_{w}. (11)

Finally, the estimated symbol boundary \hat{t}_{symbol}⁽ⁱ⁺¹⁾ can be obtained from

\hat{t}_{symbol}⁽ⁱ⁺¹⁾=\hat{t}_{signal}⁽ⁱ⁺¹⁾−c_{0,0}T_{c}. (12)

It should be noted here that the proposed algorithm is inoperable for some specific TH patterns, for example D_{0,p}=D_{0,q} for each p≠q. Therefore, the TH code {c_{0,j}}ⱼ₌₀^{N}^{_{f}}⁻¹ must be constrained to satisfy D_{0,p}=D_{0,q} for some p≠q in order to rule out this particular case. Furthermore, the polarity change of the first pulse of the following symbol must be consistent with that of any pulse of the current symbol to ensure that the synchronization algorithm obtains an optimal performance.

A series of simulations are performed to evaluate the performance of the proposed TDLC algorithm. The multi-path channels are generated using the UWB channel model proposed by IEEE 802.15.3a [6], with parameters (1/Λ,1/λ,Γ,γ)=(42.9,0.4,7.1,4.3) ns. The channel impulse response is assumed to be invariant over one symbol duration. For each user k, assuming the propagation delay of the first arrival signal τ_{k,1} is uniformly distributed over [0,Tₛ) ns, with Tₛ=N_{f}×T_{f}. The frame duration is specified as T_{f}=35 ns, and each symbol contains N_{f}=32 frames. For the desired user (indexed as 0), a TH code {c_{0,j}}ⱼ₌₀^{N}^{_{f}}⁻¹ which satisfies D_{0,p}≠D_{0,q} for each p≠q is selected. The remaining users are assigned random TH codes uniformly distributed over [0,N_{c}) with N_{c}=35 and T_{c}=1 ns. The training sequence for the DA TDT comprises a repeated pattern (1, 1, −1, −1) for all users. For the TDLC algorithm, the transmitted data sequence, d_{0,i}, is randomly generated. Finally, the delay time, T_{w}, is set to 16 ns in all simulations of the TDLC algorithm.

FIGS. 8 and 9 show the simulation results obtained by the TDLC algorithm and the TDT algorithms for the probability of detection (PD) and the normalized mean square error (MSE), respectively. It can be seen that the TDLC algorithm outperforms the TDT algorithms. This result is reasonable since the DLC receiver uses the unique time interval between two successive pulses, D_{k,p}, as the time delay to correlate the received signal with the time-delayed signal. Therefore, it is more robust to noise and interference than the DT receiver. The simulation results show that the TDLC algorithm provides a better performance than TDT algorithms with smaller values of K, for instance K=1, in both multi-path and multi-user environments.

The present invention provides a novel non-data aided (NDA) timing synchronization algorithm designated as the “timing with delay line combination” (TDLC) algorithm. The TDLC algorithm can detect the correct symbol boundary within one symbol duration. Furthermore, the synchronization speed of the TDLC algorithm is 2K×Nᵢ times faster than that of the TDT algorithms. The simulation results have shown that the TDLC algorithm achieves a higher probability of detection (PD) and a lower normalized mean square error (MSE) than TDT algorithms in both multi-path and multi-user environments.

As is understood by a person skilled in the art, the foregoing preferred embodiment of the present invention is an illustration, rather than a limiting description, of the present invention. It is intended to cover various modifications and similar arrangements. all the above may vary and should be considered within the spirit and scope of the appended claims of the present invention. In short, the spirit and scope should be accorded the broadest interpretation so as to encompass all such modifications and similar structures.

### BRIEF DESCRIPTION OF THE DRAWINGS

FIG. 1 is a diagram showing the structure of differential correlator.

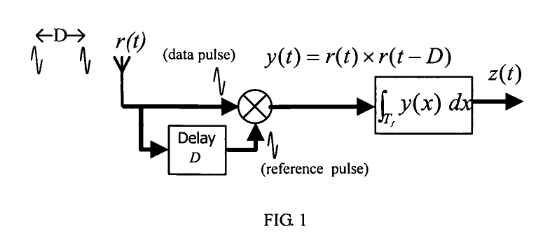

FIG. 2 is a diagram showing the structure of frame differential receiver.

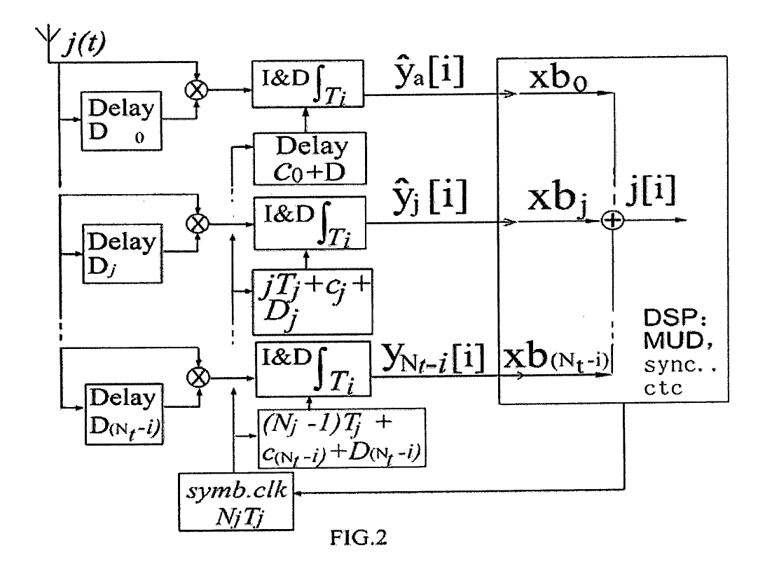

FIG. 3 is a block diagram of the UWB transmitter and receiver for timing with dirty template (TDT) synchronization algorithm

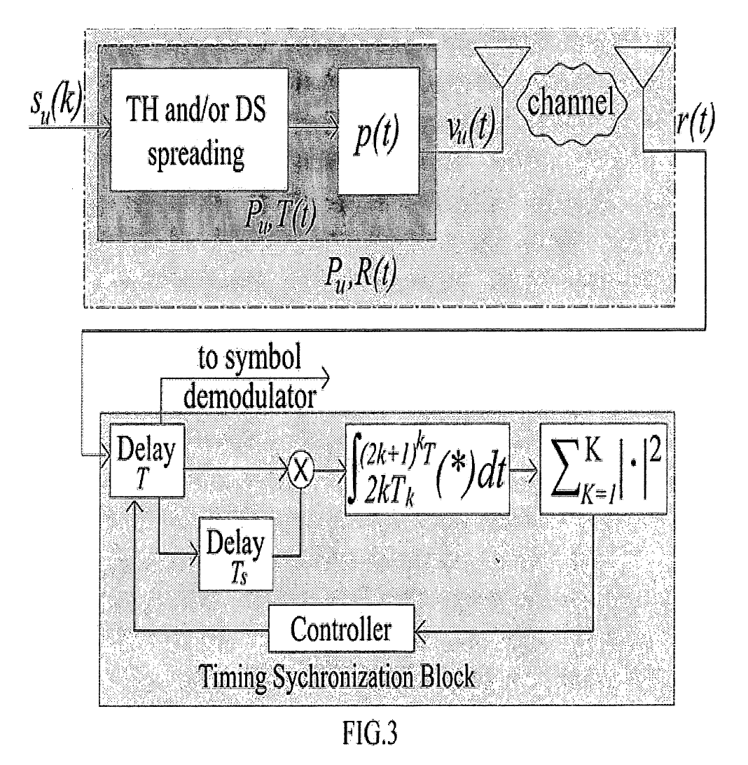

FIG. 4 is a diagram showing the structure of the frame-differential delay line of the present invention.

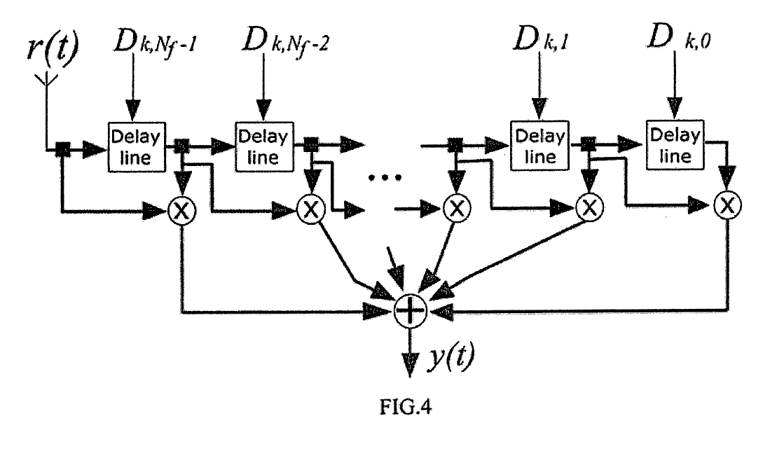

FIG. 5 is a diagram showing the structure of present invention.

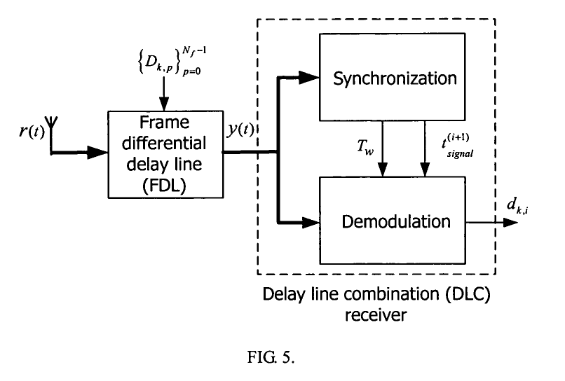

FIG. 6 is a block diagram of the present invention.

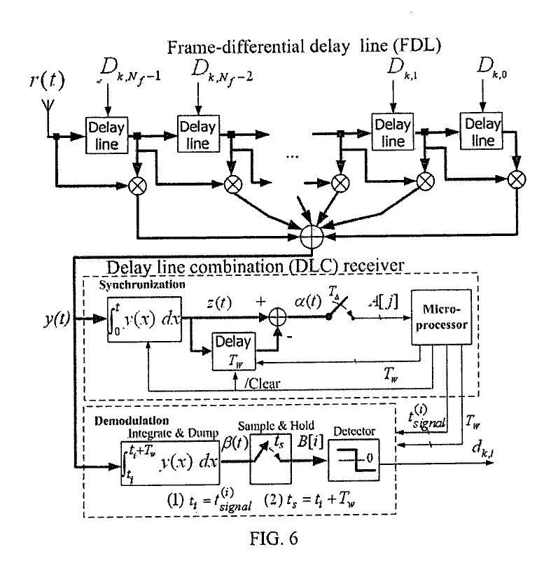

FIG. 7. is simulated output of z(t) and α(t) for the 0th user with

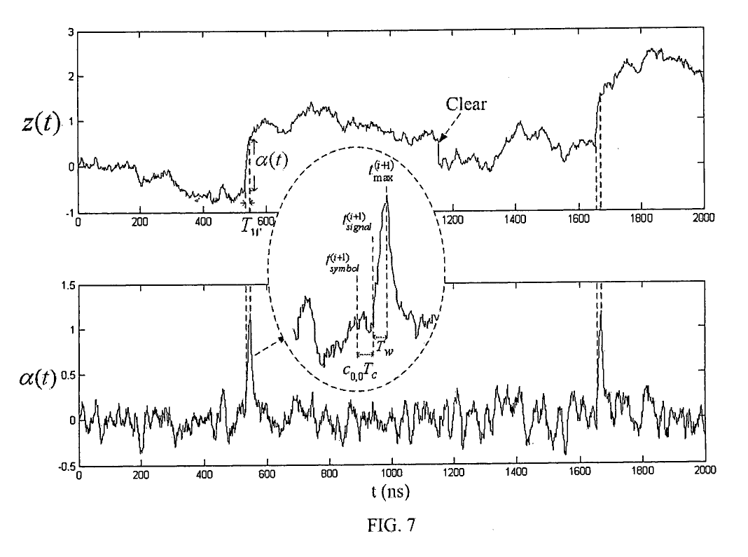

$${E}_{b} / {N}_{o} = 10 dB$$

FIG. 8 is a Probability of detection (PD) with frame-level coarse timing synchronization.

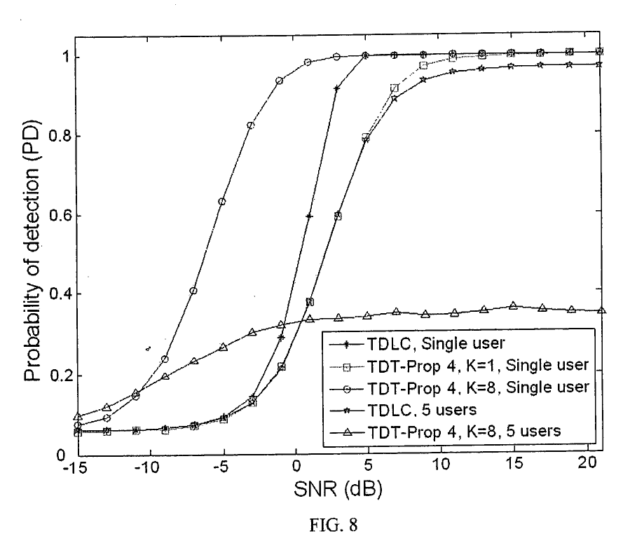

FIG. 9 is normalized mean square error (MSE)

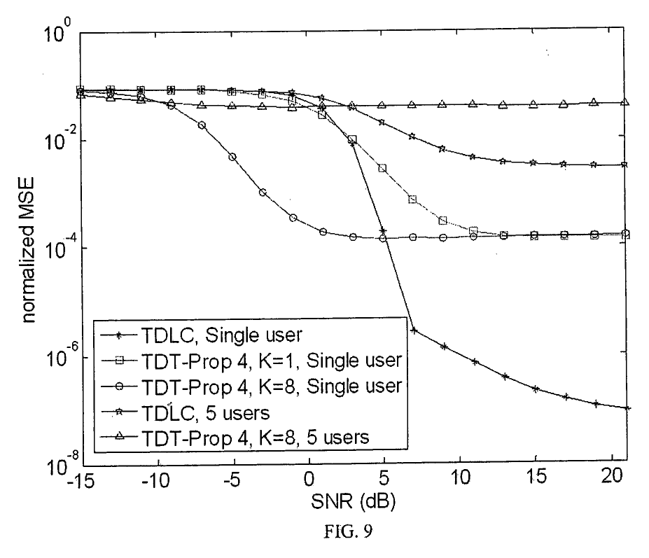

### REFERENCES

[1] Y.-L. Chao and R. A. Scholtz, “Optimal and suboptimal receivers for ultra-wideband transmitted reference systems,” in IEEE Global Telecommunications Conference, GLOBECOM, San Francisco, Calif., vol. 2, pp. 759-763, December 2003.
[2] Tony Q. S. Quek and Moe Z. Win, “Analysis of UWB Transmitted-Reference Communication Systems in Dense Multi-path Channels,” IEEE J Select. Areas Communications, vol. 23, no 9, pp. 1863-1874, September 2005.
[3] K. Witrisal and M. Pausini, “Equivalent System Model of ISI in a Frame-differential IR-UWB Receiver,” Proceedings of the IEEE Global Telecommunications Conference, GLOBECOM, Dallas, Tex., vol. 6, December 2004, pp. 3505-3510.
[4] K. Witrisal, G. Leus, M. Pausini, and C. Krall, “Equivalent system model and equalization of differential impulse radio UWB systems,” IEEE J Sel. Areas Commun., vol. 23, no. 9, pp. 1851-1862, September 2005.
[5] L. Yang and G. B. Giannakis, “Timing ultra-wideband signals with dirtytemplates,” IEEE Trans. Commun., vol. 53, no. 11, pp. 1952-1963, November 2005.
[6] J. R. Foerster, et al., “Channel Modeling Subcommittee Report Final,” IEEE p802.15-02/368r5-SG3a, 18 Nov. 2002. [http://grouper.ieee.org/groups/802/15/pub/2002/Nov2]

What is claimed:

1. A delay line combination receiving method for ultra wideband system, characterized by collecting and combining all multi-path signals from desired users with a frame-differential delay line in candidate.

2. A delay line combination receiving method for ultra wideband system as in claim 1, wherein the candidate time offsets of transmitted signals from desired users could be pre-decided or adjusted.

3. A delay line combination receiving method for ultra wideband system as in claim 2, wherein the candidate time offsets of transmitted signals from desired users could be pre-decided or adjusted.

4. A delay line combination receiving method for ultra wideband system as in claim 1, wherein a timing with delay line combination algorithm could be included for detecting the time at sharpest rising or falling edge of the continuous integration output of the combinative output signal provided by said frame-differential delay line, said the time at the sharpest rising or falling edge of the continuous integration output is the arrival time of the first signal of each symbol.

5. A delay line combination receiving method for ultra wideband system as in claim 2, wherein a timing with delay line combination algorithm could be included for detecting the time at sharpest rising or falling edge of the continuous integration output of the combinative output signal provided by said frame-differential delay line, said the time at the sharpest rising or falling edge of the continuous integration output is the arrival time of the first signal of each symbol.

6. A delay line combination receiving method for ultra wideband system as in claim 1, wherein a demodulation process is used for signal demodulation.

7. A delay line combination receiving method for ultra wideband system as in claim 2, wherein a demodulation process is used for signal demodulation.

8. A delay line combination receiving method for ultra wideband system as in claim 4, wherein a demodulation process is used for signal demodulation.

9. A delay line combination receiving method for ultra wideband system as in claim 5, wherein a demodulation process is used for signal demodulation.
